(19) United States
(12) Patent Application Publication
(10) Pub. No.: US 2023/0305140 A1
(43) Pub. Date: Sep. 28, 2023

(54) Method and Apparatus for Multi-Processor Radar Signal Processing

(71) Applicants: Ramesh Annavajjala, Natick, MA (US); Kuntal Chowdhury, Andover, MA (US)

(72) Inventors: Ramesh Annavajjala, Natick, MA (US); Kuntal Chowdhury, Andover, MA (US)

(21) Appl. No.: 17/682,780

(22) Filed: Feb. 28, 2022

(51) Int. Cl. G01S 13/87; G01S 13/72

(52) U.S. Cl. CPC G01S 13/872; G01S 13/726

(57) ABSTRACT

Radar signal processing is performed using a plurality of signal processing units onboard a radar sensor unit. One of the signal processing units is designated as the primary processor whereas the remaining signal processing units are designated as secondary processors. Secondary processors, based on their configuration and capability, perform a subset of radar signal processing tasks. Secondary processors transmit a compressed bit stream of their partially processed results to the primary processor. The primary processor decompresses the bit streams received from a plurality of secondary processors, incorporates the partially processed results from a plurality of secondary processors with its locally processed results, performs final detections, and sends the final detections to a remote processor. When secondary processors perform detections in range, Doppler, and angle domains, and sends those to the primary processor, the primary processor employs consensus detection to produce final detections.

### DETAILED DESCRIPTION OF THE INVENTION

The embodiments of our invention provide methods for radar signal processing with a plurality of radar front end modules and signal processing units distributed within a radar unit.

FIG. 1 shows architecture of a radar sensor 101 comprised of an antenna array 102, a primary processing unit 103, a plurality of secondary processing units 106, and a remote processor 109 according to the embodiments of our invention. The primary processing unit 103 functionality is divided into radar front end 104 and signal processing unit 105. The functionality of each secondary processor 106 is divided into radar front end 107 and signal processing unit 108. The number of transmit and receive channels on 104 and 107 are independently configured to optimize the overall front-end performance, power consumption, and cost. In a similar manner, the compute capability in 105 and 108 is independently configured to optimize the overall radar signal processing performance. The antenna array 102 is responsible for transmission and reception of high-frequency radar waveforms over the air. Example antenna array designs include patch antennas and substrate-integrated waveguide (SIW) antenna arrays. Radar front ends 104 and 107 are responsible for creating radar waveforms at a particular operating frequency occupying a certain waveform bandwidth. Waveform duration, transmission power levels, number of transmit and receive antennas to be used, duty cycle of the waveform, resolution of the digitized radar returns are some of the other configurations of 104 and 107 that are communicated by the remote processor 109.

The signal processing units 105 and 108 in FIG. 1 are integrated with the respective front-end modules 104 and 107. Each secondary signal processing unit 108 has access to the digitized radar return samples from the front end 107 and performs partial radar signal processing over the transmit and receive channels available to 107. Some of the partial radar processing configurations are range processing on each pulse on each antenna channel, range-Doppler processing spanning over several pulses on each antenna channel, or range-Doppler-angle processing spanning over several pulses and a plurality of antenna channels. Partial radar signal processing results are transmitted from secondary processing units to the primary processor in a compressed mode over inter-chip interfaces such as serial peripheral interface (SPI) or camera serial interface (CSI) from Mobile Industry Processor Interface (MIPI) standard (or, MIPI-CSI).

The primary signal processing unit 105 has access to the digitized radar return samples from the front end 104 and performs intermediate radar signal processing. The primary signal processor decompresses the partial radar signal processing results from the secondary processors and includes them with the intermediate radar signal processing results to produce the final detections. The final detections are packetized and sent to the remote processor 109 over interfaces such as a CAN (controller area network) bus or an Ethernet interface.

FIG. 2 shows an architecture of a radar sensor 201 comprised of an antenna array 202, a primary front end 203, a primary signal processing unit 204, a plurality of secondary front ends 205, a plurality of secondary signal processing units 206, and a remote processor 207 according to the embodiments of our invention.

The signal processing unit 204 is interfaced with the radar front end 203 using interfaces such as Peripheral Component Interconnect Express (PCle) bus, SerDes (serializer-deserializer) bus, and MIPI-CSI. In a similar manner, 205 and 206 are connected using interfaces such as PCle, SerDes, or MIPI-CSI. Secondary processors 206 perform partial radar signal processing on transmit and receive channels available to 205 and are transmitted to the primary processor 204 in a compressed mode over interfaces such as SPI or MIPI-CSI. The primary signal processor 204 decompresses the partial radar signal processing results from the secondary processors and includes them with the intermediate signal processing results to generate the final detections. The final detections are packetized and sent to remote processor 207 over interfaces such as a CAN bus or an Ethernet interface.

FIG. 3 shows a partial radar signal processing flow on a secondary signal processing unit including the ADC buffer 301, range-domain processing 302, Doppler-domain processing 303, range-Doppler sample buffer 304, non-coherent integration 305, compression 306, and compression configuration 307 according to the embodiments of our invention.

The ADC sample buffer data 301 on a secondary processor is organized into a three-dimensional grid of M samples per pulse (dimension 1), N pulses (dimension 2), and L antenna channels (dimension 3). Here, M, N and L are configurable either from the primary processor or from the remote processor. Range processing 302 is done by first applying an optional window transformation to the M samples in the first dimension and then performing an MR-point FFT to produce MR range bins. Here, MR is the range FFT processing block size which is not smaller than M. Window transformation is needed to reduce the side lobes. Example window transforms include Hann window and Hamming window. The number of range-FFT transforms is given by N*L. Doppler processing 303 is performed in the second dimension with a Doppler FFT size of ND to produce MR*L Doppler data streams, each stream containing ND Doppler bins. A window is optionally applied to the N pulses before the ND-point Doppler FFT operation for each range bin on each receive antenna. If MR is larger than M, zero padding is applied to the range samples. If ND is larger than N, zero padding is applied to the pulses. [Reference: M. A. Richards, Fundamentals of Radar Signal Processing, 2nd Ed., New York, NY, USA: McGraw-Hill, 2014.].

The range-Doppler data on the secondary processor is organized into a three-dimensional grid of sizes MR (first dimension), ND (second dimension), and L (third dimension). Range-Doppler data is stored in 304. Noncoherent integration 305 on a range-Doppler bin is performed by adding the absolute squared values from each antenna channel corresponding to that range-Doppler bin to produce a power value for that range-Doppler bin. After the noncoherent integration, the range-Doppler power samples are organized into a two-dimensional matrix of MR (rows) and ND (columns). The MR*ND power values are compressed by 306 with compression configuration 307 received from the primary processor. Example compression algorithms include predictive waveform quantization (PWQ), delta modulation (DM), vector quantization (VQ), and data-driven codebook based adaptive vector quantization (AVQ). The compressed range-Doppler power samples are sent to the primary processor.

When the primary processor requests antenna samples belonging to a group of range-Doppler bins, the primary processor transmits a set of range-Doppler indices to the second processor over the inter-processor interface. These range-Doppler indices are used by the secondary processor to extract the antenna samples from 304 and compress them in 306 using the compression configuration from 307. Compressed antenna samples of the range-Doppler indices are transmitted to the primary processor over the inter-processor interface.

In one embodiment, the secondary processor can also be configured to perform only the range processing. In this configuration, the secondary processor sends compressed power measurements on each range bin after noncoherent accumulation of range bin samples across the antenna channels to the primary processor. The primary processor requests antenna samples from a group of range bins, and the secondary processor extracts those antenna samples from 304, compresses 306, and transmits them to the primary processor over the inter-processor interface.

FIG. 4 shows range-Doppler-angle signal processing on the primary processing unit incorporating partial radar signal processing results received from a plurality of secondary processors including ADC sample buffer 401, range-domain processing 402, Doppler-domain processing 403, range-Doppler sample buffer 404, noncoherent integration 405, element-by-element accumulation 406, decompression 407 of range-Doppler power data from a plurality of secondary processors, range-Doppler object detection 408, aggregation of antenna samples 409, decompression 410 of antenna samples received from a plurality of secondary processors, and antenna sample based angle estimation 411 according to the embodiments of our invention.

The ADC sample buffer data on the primary processor 401 is organized into a three-dimensional grid of M samples per pulse (dimension 1), N pulses (dimension 2), and L antennas (dimension 3). Here, M, N and L are configurable from the remote processor. Range processing 402 is done by first applying an optional window transformation to the M samples in the first dimension and then performing an MR-point FFT to produce MR range bins. The number of range-FFT transforms is given by N*L. Doppler processing 403 is performed in the second dimension with a Doppler FFT size of ND to produce MR*L Doppler data streams, each stream containing ND Doppler bins. A window is optionally applied to the N pulses before the ND-point Doppler FFT operation for each range bin on each receive antenna. If MR is larger than M, zero padding is applied to the range samples. If ND is larger than N, zero padding is applied to the pulses.

The range-Doppler data on the primary processor is organized into a three-dimensional grid of sizes MR (first dimension), ND (second dimension), and L (third dimension). Range-Doppler data is stored in 404. Noncoherent integration 405 on a range-Doppler bin is performed by adding the absolute squared values from each antenna corresponding to that range-Doppler bin to produce a power value for that range-Doppler bin. After the noncoherent integration, the range-Doppler power samples are organized into a two-dimensional matrix of MR (rows) and ND (columns).

The primary processor receives a compressed stream of MR*ND range-Doppler power values from a secondary processor. The primary processor decompresses this stream 407 and adds them element by element with the locally computed power samples in 406. Once the range-Doppler power values are accumulated from all the secondary processors, the primary processor performs range-Doppler object detection 408. The output of the range-Doppler object detection is a list of detections with a range bin index and a Doppler bin index associated with each detection. The primary processor sends a list of range and Doppler bin indices to each secondary processor from which it received the compressed range-Doppler power matrix to request for the antenna samples belonging to the detected range and Doppler indices.

Upon receiving the compressed antenna samples from a secondary processor, the primary processor decompresses it in 410 and stores them in antenna sample buffer 409. The antenna sample buffer is organized into a two-dimensional matrix. The rows of the two-dimensional matrix correspond to the detected object index and the columns correspond to the antenna samples from all the processors. As an example, with one primary processor configured with 3 transmit and 4 receive antenna channels and two secondary processors each configured with 2 transmit and 2 receive antenna channels, the number of columns of the antenna sample buffer matrix are (3*4) + (2*2) + (2*2) =20. Columns 1 through 12 contain the antenna samples from the primary processor, columns 13 through 16 contain the antenna samples from the first secondary processor, and columns 17 through 20 contain the antenna samples from the second secondary processor.

Once the antenna samples are present in the antenna buffer from all the processors, azimuth and elevation angle estimation 411 is performed for each detected object. Example angle estimation algorithms include Minimum Variance Distortion-less Response (MVDR) beamformer, Bartlett beamformer, FFT based angle estimation and Multiple Signal Classification (MUSIC) based angle estimation. After the angle estimation is done, the four-dimensional coordinates (range, Doppler, azimuth angle, elevation angle) of each detected object along with the detection confidence as measured by the estimated signal to noise ratio (SNR), signal power, noise power, or radar cross section (RCS) of the object are transmitted to the remote processor.

FIG. 5 shows a partial radar signal processing flow on a secondary signal processing unit including the ADC buffer 501, range-domain processing 502, Doppler-domain processing 503, range-Doppler sample buffer 504, noncoherent integration 505, range-Doppler object detection 506, compression 507, and compression configuration 508 according to the embodiments of our invention.

The ADC sample buffer data 501 on a secondary processor is organized into a three-dimensional grid of M samples per pulse (dimension 1), N pulses (dimension 2), and L antennas (dimension 3). Here, M, N and L are configurable either from the primary processor or from the remote processor. Range processing 502 is done by first applying an optional window transformation to the M samples in the first dimension and then performing an MR-point FFT to produce MR range bins. The number of range-FFT transforms is given by N*L. Doppler processing 503 is performed in the second dimension with a Doppler FFT size of ND to produce MR*L Doppler data streams, each stream containing ND Doppler bins. A window is optionally applied to the N pulses before the ND-point Doppler FFT operation for each range bin on each receive antenna.

The range-Doppler data on the secondary processor is organized into a three-dimensional grid of sizes MR (first dimension), ND (second dimension), and L (third dimension). Range-Doppler data is stored in 504. Noncoherent integration 505 on a range-Doppler bin is performed by adding the absolute squared values from each antenna channel corresponding to that range-Doppler bin to produce a power value for that range-Doppler bin. After the noncoherent integration, object detection 506 is performed in range and Doppler bins. Detected object list along with the range and Doppler indices of each object are used to extract the range-Doppler-antenna samples from 504. Range-Doppler-antenna samples for each detected object are compressed 507 using the compression configuration 508 received from the primary processor, and the compressed samples are transmitted to the primary processor.

FIG. 6 shows range-Doppler-angle signal processing on the primary signal processing unit incorporating partial radar signal processing results received from a plurality of secondary processors including ADC sample buffer 601, range-domain processing 602, Doppler-domain processing 603, range-Doppler sample buffer 604, noncoherent integration 605, range-Doppler object detection 606, antenna sample buffer 607, decompression 608 of antenna samples received from a plurality of secondary processors, and angle estimation 609 according to the embodiments of our invention.

The ADC sample buffer data on the primary processor 601 is organized into a three-dimensional grid of M samples per pulse (dimension 1), N pulses (dimension 2), and L antennas (dimension 3). Here, M, N and L are configurable from the remote processor. Range processing 602 is done by first applying an optional window transformation to the M samples in the first dimension and then performing an MR-point FFT to produce MR range bins. The number of range-FFT transforms is given by N*L. Doppler processing 603 is performed in the second dimension with a Doppler FFT size of ND to produce MR*L Doppler data streams, each stream containing ND Doppler bins. A window is optionally applied to the N pulses before the ND-point Doppler FFT operation for each range bin on each receive antenna. If MR is larger than M, zero padding is applied to the range samples. If ND is larger than N, zero padding is applied to the pulses.

The range-Doppler data on the primary processor is organized into a three-dimensional grid of sizes MR (first dimension), ND (second dimension), and L (third dimension). Range-Doppler data is stored in 604. Noncoherent integration 605 on a range-Doppler bin is performed by adding the absolute squared values from each antenna corresponding to that range-Doppler bin to produce a power value for that range-Doppler bin. After the noncoherent integration, the range-Doppler power samples are organized into a two-dimensional matrix of MR (rows) and ND (columns) and object detection is performed 606. The output of the range-Doppler object detection is a set of detections with a range bin index and a Doppler bin index associated with each detection. For each detected range and Doppler index, antenna samples are extracted from 604 and stored in 607.

Upon receiving compressed antenna data samples on each detected range and Doppler bin from a secondary processor, the primary processor decompresses them using the decompression configuration 608 and stores then in the antenna sample buffer 607.

Once the antenna samples are present in the antenna buffer from all the processors, azimuth and elevation angle estimation 609 is performed for each detected object. After the angle estimation is complete, the four-dimensional coordinates (range, Doppler, azimuth angle, elevation angle) of each detected object along with the detection confidence as measured by the estimated SNR, noise power, or RCS of the object are transmitted to the remote processor.

FIG. 7 shows partial radar signal processing flow on a secondary signal processing unit including the ADC buffer 701, range-domain processing 702, Doppler-domain processing 703, noncoherent integration 704, range-Doppler object detection 705, angle estimation 706, packetized list of detections 707, compression 708, and compression configuration 709 according to the embodiments of our invention.

The ADC sample buffer data 701 on a secondary processor is organized into a three-dimensional grid of M samples per pulse (dimension 1), N pulses (dimension 2), and L antennas (dimension 3). Here, M, N and L are configurable either from the primary processor or from the remote processor. Range processing 702 is done by first applying an optional window transformation to the M samples in the first dimension and then performing an MR-point FFT to produce MR range bins. The number of range-FFT transforms is given by N*L. Doppler processing 703 is performed in the second dimension with a Doppler FFT size of ND to produce MR*L Doppler data streams, each stream containing ND Doppler bins. A window is optionally applied to the N pulses before the ND-point Doppler FFT operation for each range bin on each antenna channel.

The range-Doppler data on a secondary processor is organized into a three-dimensional grid of sizes MR (first dimension), ND (second dimension), and L (third dimension). Range-Doppler data is stored in 704. Noncoherent integration 705 on a range-Doppler bin is performed by adding the absolute squared values from each antenna corresponding to that range-Doppler bin to produce a power value for that range-Doppler bin. After the noncoherent integration, object detection 706 is performed in range and Doppler bins. For each detected object, angle estimation is performed in azimuth and elevation 706 and detections are packetized into a list 707 containing the number of detected objects, range, Doppler, azimuth and elevation angles, and the quality of detections as measured by the SNR or the estimated RCS. Packetized list of detections 707 are compressed 708 using the compression configuration 709 and are transmitted to the primary processor. In one embodiment, the secondary processor can also choose to compress the list of detections followed by packetization with operations 708 and 709 preceding operation 707.

FIG. 8 shows range-Doppler-angle signal processing on the primary signal processing unit incorporating partial radar signal processing results received from a plurality of secondary processors including ADC sample buffer 801, range-domain processing 802, Doppler-domain processing 803, noncoherent integration 804, range-Doppler object detection 805, angle estimation 806, consensus detection 807 using the de-packetized list of detections 808 from a plurality of secondary processing units, decompression 809, and decompression configuration 810 according to the embodiments of our invention.

The ADC sample buffer data on the primary processor 801 is organized into a three-dimensional grid of M samples per pulse (dimension 1), N pulses (dimension 2), and L antennas (dimension 3). Here, M, N and L are configurable from the remote processor. Range processing 802 is done by first applying an optional window transformation to the M samples in the first dimension and then performing an MR-point FFT to produce MR range bins. The number of range-FFT transforms is given by N*L. Doppler processing 803 is performed in the second dimension with a Doppler FFT size of ND to produce MR*L Doppler data streams, each stream containing ND Doppler bins. A window is optionally applied to the N pulses before the ND-point Doppler FFT operation for each range bin on each receive antenna. If MR is larger than M, zero padding is applied to the range samples. If ND is larger than N, zero padding is applied to the pulses.

The range-Doppler data on the primary processor is organized into a three-dimensional grid of sizes MR (first dimension), ND (second dimension), and L (third dimension). Noncoherent integration 804 on a range-Doppler bin is performed by adding the absolute squared values from each antenna corresponding to that range-Doppler bin to produce a power value for that range-Doppler bin. After the noncoherent integration, the range-Doppler power samples are organized into a two-dimensional matrix of MR (rows) and ND (columns) and object detection is performed 805. The output of the range-Doppler object detection is a set of detections with a range bin index and a Doppler bin index associated with each detection. For each detected object, angle estimation is performed in azimuth and elevation 806.

Upon receiving the compressed and packetized list of detections from secondary processors, the primary processor performs decompression 809 using the decompression configuration 810 and extracts the list of detections, range, Doppler, azimuth and elevation angles, and the quality of detections as measured by the SNR or RCS.

Having access to independent detections from all the processors, the primary processor proceeds to perform a consensus detection 807 to produce a list of final detections. In a consensus detection, range and Doppler locations reported by multiple processors are given more confidence compared with the isolated detections produced by one or a plurality of processors.

### BRIEF DESCRIPTION OF DRAWINGS

FIG. 1 is a block diagram of a radar unit with a plurality of integrated processors interfaced with a remote processor according to embodiments of the invention.

FIG. 2 is a block diagram of a radar unit with a plurality of front-end and signal processing units interfaced with a remote processor according to embodiments of the invention.

FIG. 3 is a block diagram of range-Doppler processing on a secondary processor according to embodiments of the invention.

FIG. 4 is a block diagram of radar signal processing on the primary processor integrated with range-Doppler processing output received from a plurality of secondary processors according to embodiments of the invention.

FIG. 5 is a block diagram of range-Doppler object detection on a secondary processor according to embodiments of the invention.

FIG. 6 is a block diagram of radar signal processing on the primary processor integrated with range-Doppler object detections received from a plurality of secondary processors according to embodiments of the invention.

FIG. 7 is a block diagram of radar signal processing on a secondary processor according to embodiments of the invention.

FIG. 8 is a block diagram of radar signal processing on the primary processor integrated with packetized list of detections received from a plurality of secondary processors according to embodiments of the invention.

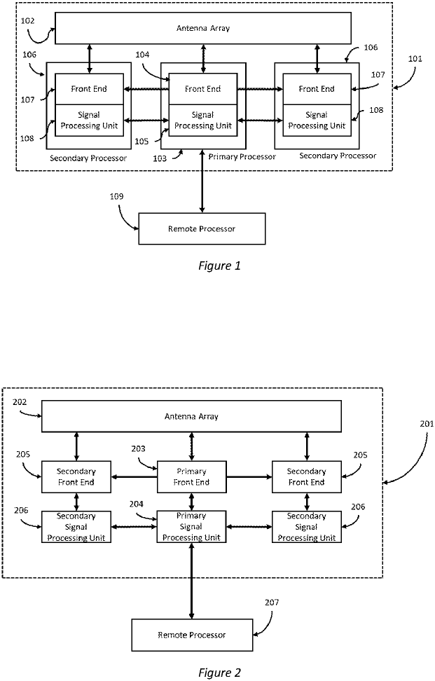

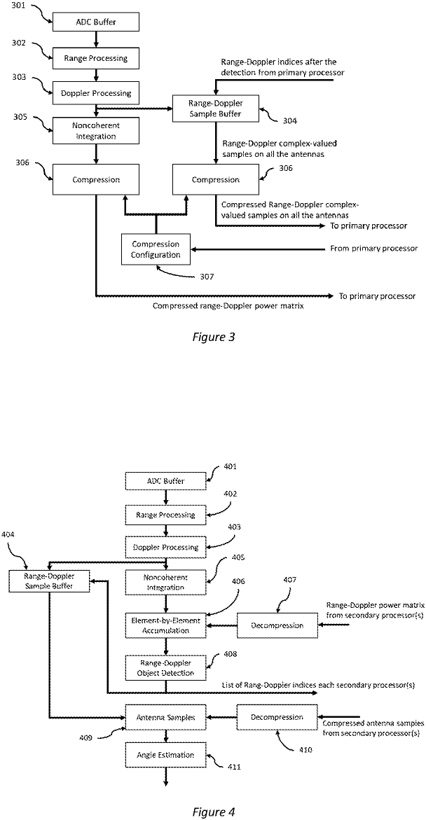

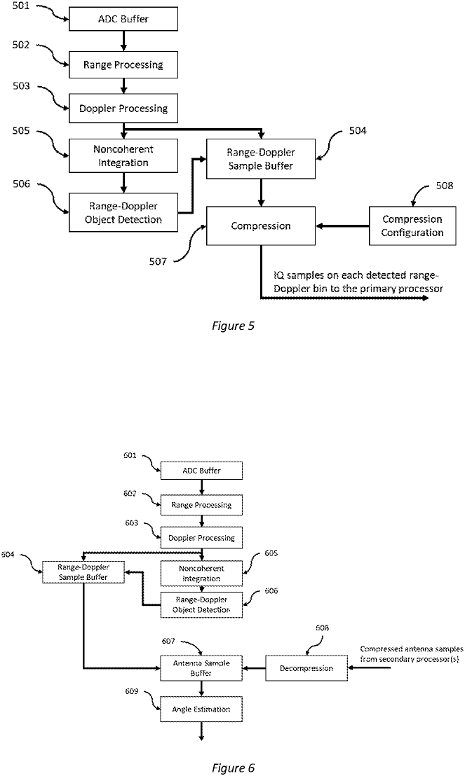

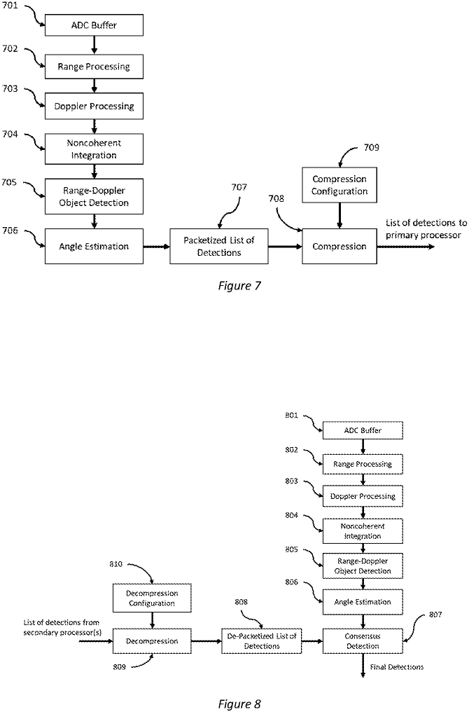

### PRIOR ART

M. A. Richards, Fundamentals of Radar Signal Processing, 2nd Ed., New York, NY, USA: McGraw-Hill, 2014.

### BACKGROUND OF THE INVENTION

A Radar sensor transmits waveform to detect the presence of objects in the environment. Waveform returns from an object contain the range of the object from the radar sensor, the velocity of the object relative to the radar sensor, and the angular position of the object in azimuth and elevation coordinates. Radar signal processing and tracking algorithms are employed to detect and track multiple objects. Examples of radar sensors include frequency-modulated continuous wave (FMCW) based radar, active electronic steerable array (AESA) radar, and pulse-Doppler radar.

Imaging radars are proven to be very effective for long range object detection and spatial separation of various objects in azimuth and elevation. Imaging radars are also privacy preserving and are socially more acceptable. Some of the applications of imaging radars include autonomous navigation for ground and aerial vehicles, unmanned air-space monitoring (UAM) for aerial mobility, perimeter monitoring and border protection for homeland security, robotics and industrial automation, precision farming, and traffic management and safety improvements in smart cities.

Long range detection with imaging radars is enabled by transmitter beamforming. The transmit power and the beamforming gain increase with the number of transmit channels. Coherent processing gain at the radar receiver increases with the number of receive channels. Angular resolution improves with the product of number of transmit and receive channels in a virtual antenna aperture operating mode using time-division-multiplexing based multiple transmit and multiple receive channels (TDM-MIMO).

The radar front end complexity, power consumption, and cost increase significantly with the number of transmit and receive channels. The number of power amplifiers, programmable gain amplifiers, programmable phase shifters, and the digital-to-analog converters (DACs) required increases with the number of transmit channels. On the other hand, the number of analog-to-digital converters (ADCs) required increases with the number of receive channels.

Performing radar signal processing on the samples received from many ADCs is computationally challenging. The number of Fast Fourier Transform (FFT) computations required for range and Doppler processing increase linearly with the number of ADC channels. Angular processing complexity increases with the product of number of transmit and receive antennas. Power consumption, cost, and complexity of a dedicated processor to perform four-dimensional imaging radar signal processing increases with the number of transmit and receive channels.

### SUMMARY OF THE INVENTION

The embodiments of the invention provide methods to perform radar signal processing using a plurality of processors onboard a radar sensor.

The methods provide configuring one of the processors as the primary processor and the remaining processors as secondary processors.

The methods provide range domain radar signal processing on secondary processors, transmission of compressed range domain power measurements from secondary processors to the primary processor, decompression of range domain power measurements received from the secondary processors at the primary processor, and performing range domain processing, Doppler domain processing, object detection, and angle estimation on the primary processor.

The methods provide range and Doppler domain radar signal processing on secondary processors, transmission of compressed range and Doppler domain power measurements from secondary processors to the primary processor, decompression of range and Doppler domain power measurements received from the secondary processors at the primary processor, and performing range domain processing, Doppler domain processing, object detection, and angle estimation on the primary processor.

The methods provide range, Doppler, and angle domain radar signal processing on secondary processors, transmission of compressed range, Doppler, and angle domain power measurements from secondary processors to the primary processor, decompression of range, Doppler, and angle domain power measurements received from the secondary processors at the primary processor, and performing range domain processing, Doppler domain processing, object detection, and angle estimation on the primary processor.

The methods provide object detection on secondary processors, transmission of compressed and packetized list of detections from secondary processors to the primary processor, decompression of packetized list of detections received from the secondary processors at the primary processor and performing consensus-based object detection on the primary processor.

The methods provide compression and decompression configuration on the primary processor from the remote processor, and compression and decompression configuration on the secondary processors from the primary processor.

1. A method for processing signals received from a plurality of processors onboard a radar sensor unit.

2. The method of claim 1, wherein one of the processors onboard the radar sensor unit is designated as primary processor and the remaining processors onboard the radar sensor unit are designated as secondary processors.

3. The method of claim 1, wherein a secondary processor transmits compressed power measurements in range domain to the primary processor.

4. The method of claim 1, wherein the primary processor decompresses the power measurements in range domain received from a plurality of secondary processors.

5. The method of claim 1, wherein the primary processor transmits a list of object locations in range domain to a plurality of secondary processors.

6. The method of claim 1, wherein a secondary processor transmits compressed complex-valued antenna channel samples of range bin object locations to the primary processor.

7. The method of claim 1, wherein the primary processor decompresses complex-valued antenna channel samples of range bin object locations received from a plurality of secondary processors.

8. The method of claim 1, wherein a secondary processor transmits compressed power measurements in range and Doppler domains to the primary processor.

9. The method of claim 1, wherein the primary processor decompresses the power measurements in range and Doppler domains received from a plurality of secondary processors.

10. The method of claim 1, wherein the primary processor transmits a list of object locations in range and Doppler domains to a plurality of secondary processors.

11. The method of claim 1, wherein a secondary processor transmits compressed complex-valued antenna channel samples of range-Doppler bin object locations to the primary processor.

12. The method of claim 1, wherein the primary processor decompresses the complex-valued antenna channel samples of range-Doppler bin object locations received from a plurality of secondary processors.

13. The method of claim 1, wherein a secondary processor transmits a compressed packetized list of detections to the primary processor.

14. The method of claim 1, wherein the primary processor decompresses detection packets received from a plurality of secondary processors.

15. The method of claim 1, wherein the primary processor performs consensus detection using the detections generated locally on the primary processor and the detections received from a plurality of secondary processors.
